(19) United States
(12) Patent Application Publication
(10) Pub. No.: US 2014/0271993 A1
(43) Pub. Date: Sep. 18, 2014

(54) LOW CARBOHYDRATE, HIGH PROTEIN, FIBER ENRICHED GELATO FORMULATION AND METHOD OF MANUFACTURE

(71) Applicants: LEONARDO CARELLA, Richmond Hill (CA); Peter Salvaggio, Richmond Hill, CA (US); Enzo Salvaggio, Maple (CA); Vito Salvaggio, North York (CA)

(72) Inventors: LEONARDO CARELLA, Richmond Hill (CA); Peter Salvaggio, Richmond Hill, CA (US); Enzo Salvaggio, Maple (CA); Vito Salvaggio, North York (CA)

(21) Appl. No.: 14/287,955

(22) Filed: May 27, 2014

Related U.S. Application Data
(63) Continuation of application No. 12/962,004, filed on Dec. 7, 2010.

(30) Foreign Application Priority Data
Dec. 7, 2009 (CA) PCT/CA2009/001782

(51) Int. Cl. A23G 9/32

(52) U.S. Cl. CPC A23G 9/32
USPC 426/61; 426/565; 426/548; 426/72; 426/74; 426/71

(57) ABSTRACT

The present matter provides a gelato formulation that is low in carbohydrate, high in protein, and fiber enriched having similar taste, body and texture of traditional gelatos, and a method of making the same.

### CROSS-REFERENCE TO RELATED APPLICATION

This application is a continuation of U.S. patent application Ser. No. 12/962,004 filed Dec. 7, 2010, which application claims the benefit of the prior filing of the International Patent Application Serial No. PCT/CA2009/001782 filed Dec. 7, 2009, under 35 U.S.C. 120 and incorporates by reference the disclosure of said applications in their entirety.

### FIELD OF THE INVENTION

The present matter relates to gelato formulations and in particular to a low carbohydrate, high protein, fiber enriched gelato formulation.

### BACKGROUND OF THE INVENTION

Gelato is a well known Italian frozen dessert, that is a variation to traditionally known ice cream. Gelato represents a way of life in Italy. It is a tradition to go to a cafe in the afternoon and relax with some fresh gelato. Anyone who travels to Italy boasts about how much gelato they have eaten, and how much better it is than ice-cream.

As food requirements from consumers change, in particular with respect to dietary requirements, there is a need to amend known products, even those that are frequently consumed, to accommodate such requirements/demands.

The present matter therefore provides a gelato formulation that is low in carbohydrate, high in protein, and fiber enriched having similar taste, body and texture of the traditional gelatos.

### SUMMARY OF THE INVENTION

A gelato formulation is provided that is low in carbohydrate, high in protein, and fiber enriched having a similar taste, body and texture of traditional gelatos.

In one aspect, the gelato formulation of the present matter comprises (a) carbohydrates in an amount of from about 0 to about 45% by weight, based on the total weight of the gelato formulation; (b) protein in an amount of from about 0 to about 50% by weight, based on the total weight of the gelato formulation; (c) fiber in an amount of from about 0 to about 30% by weight, based on the total weight of the gelato formulation; (d) polyols (sugar-alcohol) in an amount of from about 0 to about 35% by weight, based on the total weight of the gelato formulation; (e) high-intensity sweetener in an amount of from about 0 to about 10% by weight, based on the total weight of the gelato formulation; (f) sugar in an amount of from about 0 to about 35% by weight, based on the total weight of the gelato formulation; (g) non-fat milk solids in an amount of from about 0 to about 25% by weight, based on the total weight of the gelato formulation; (h) fat in an amount of from about 0 to about 25% by weight, based on the total weight of the gelato formulation; (i) water in an amount of from about 0 to about 85% by weight, based on the total weight of the gelato formulation; (j) flavouring in an amount of from about 0 to about 35% by weight, based on the total weight of the gelato formulation; (k) stabilizer in an amount of from about 0 to about 5% by weight, based on the total weight of the gelato formulation; and (l) emulsifier in an amount of from about 0 to about 5% by weight, based on the total weight of the gelato formulation.

In another aspect, the gelato formulation of the present matter comprises 0-30% carbohydrate by weight, 0-50% protein by weight; 0-30% fiber by weight; 0-35% polyol by weight; 0-10% high intensity sweetener by weight, 0-35% sugar by weight; 0-25% non-fat milk solids by weight, 0-30% fat by weight, 0-85% water by weight; 0-35% flavouring by weight; 0-5% stabilizer by weight; and 0-5% emulsifier.

In another embodiment, the low-carbohydrate, high-protein fiber enriched gelato formulation comprises: 0-30% carbohydrate by weight, 0-25% protein by weight, 0-15% fiber by weight, 0-25% polyols by weight, 0-1% high intensity sweetener by weight, 0-25% sugar by weight, 0-15% fat by weight, 0-10% flavouring by weight, 0-15% non-fat milk solids by weight, 0-5% stabilizer by weight, 0-5% emulsifier by weight, and 0-85% water by weight.

In a further embodiment, the low-carbohydrate, high-protein, fiber enriched gelato formulation comprises: 0-15% carbohydrate by weight, 0-25% protein by weight, 0-25% fiber by weight, 0-25% polyols by weight, 0-1% high intensity sweetener by weight, 0-15% sugar by weight, 0-15% fat by weight, 0-10% flavouring by weight, 0-15% non-fat milk solids by weight, 0-5% stabilizer by weight, 0-5% emulsifier by weight, and 0-85% water by weight.

In another embodiment, the low-carbohydrate, high-protein, fiber enriched gelato formulation comprises: 0-15% carbohydrates by weight, 8-25% protein by weight, 0-20% fiber by weight, 10-25% polyols by weight, 0-1% high intensity sweetener by weight, 0-25% sugar by weight, 0-20% fat by weight, 0-10% flavouring by weight, 0-15%, non-fat milk solids by weight, 0-1% stabilizer by weight, 0-1% emulsifier by weight, and 45-65% water by weight.

In a further embodiment, the low-carbohydrate, high-protein, fiber enriched gelato formulation comprises: 3-25% carbohydrate by weight, 10-25% protein by weight, 2-10% fiber by weight, 0-25% polyols by weight, 0-1% high intensity sweetener by weight, 0-25% sugar by weight, 0-10% fat by weight, 0-10% flavouring by weight, 0-15% non-fat milk solids by weight, 0-1% stabilizer by weight, 0-1% emulsifier by weight, and 45-70% water by weight.

In a further embodiment, the low-carbohydrate, high-protein, fiber enriched gelato formulation comprises: about 5% carbohydrates by weight, about 18% protein by weight, about 5% fiber by weight, about 15% polyols by weight, about 0% high intensity sweetener by weight, about 0% sugar by weight, about 3.5% fat by weight, about 6% flavouring by weight, about 6% non-fat milk solids by weight, about 0.30% stabilizer by weight, about 0.20% emulsifier by weight, and about 53% water by weight.

In a further embodiment, the low-carbohydrate, high-protein, fiber enriched gelato formulation comprises: about 4% carbohydrates by weight, about 17% protein by weight, about 5% fiber by weight, about 15% polyols by weight, about 0% sugar by weight, about 0% high intensity sweetener by weight, about 5.5% fat by weight, about 6% flavouring by weight, about 6% non-fat milk solids by weight, about 0.45% stabilizer by weight, about 0.25% emulsifier by weight, and about 54% water by weight.

The gelato formulation(s) described herein may further comprise vitamins, minerals, electrolytes, trace elements, oils, health supplements, prebiotics, probiotics, kefir, phytonutrients, botanical, nutraceuticals, herbs, amino acids, acidifiers, buffers, salts and any other of the like to further formulate a complete meal replacement gelato.

In some embodiments, the invention may further comprise energy-related food ingredients such as Caffeine, Taurine, Guarana, B vitamins, Ginseng, Ginkgo Biloba, L-Carnitine, Sugars, and anti-oxidants and of the like to further formulate a high energy, high-protein, high fiber sports gelato.

The present invention further provides a method for manufacturing a low-carbohydrate, high-protein, fiber enriched gelato formulation. In one aspect the method comprises the steps of: (i) blending and pre-heating of selected dry and liquid ingredients, described herein, to 40-60° C. producing a gelato mix; (ii) pasteurization of the gelato mix; (iii) homogenization of the gelato mix; (iv) cooling to 2-4° C. and aging the gelato mix for 4-24 hours; (v) freezing the gelato mix to −7 to −10° C. with an overrun range of 0-100%; (vi) packaging the finished gelato product.

In another embodiment, the method further comprises the step of the addition of low-carb, high protein inclusions prior to packaging of the finished gelato product.

This invention also provides a method of manufacturing a low-carbohydrate, high protein Fiber enriched (soft serve) gelato formulation, wherein the gelato formulation is as described herein and the method comprises the steps of: (i) the blending and pre-heating of selected liquid and dry ingredients to 40-60° C. producing a gelato mix; (ii) pasteurization of the gelato mix; (iii) homogenization of the gelato mix; (iv) cooling homogenized gelato mix to 2-4° C.; and (v) packaging the liquid gelato mix into 5 litre and/or 10 litre bags for Soft-Serve purposes.

The invention also provides a method of manufacturing a low-carbohydrate, high-protein, fiber enriched, fruit &water based, sorbet-gelato formulation, wherein the formulation comprises: 0-25% carbohydrate by weight, 5-25% protein by weight, 0-25% fiber by weight, 0-28% polyols by weight, 0-1% high intensity sweetener by weight, 0-28% sugar by weight, 0-100% fruit by weight, 0-30% flavouring by weight, and 0-85% water by weight, the method comprising the steps of: (i) mix the selected dry ingredients in a large container; (ii) prepare a mixture of fruit and water, slowly adding the mixed dry ingredients while blending; (iii) let stand for 20-30 minutes; (iv) freezing the sorbet-gelato mix to −7 to −10° C. with an overrun range of 0-100%; (v) packaging the finished gelato product.

In one embodiment, the gelato formulation described herein may further comprise stabilizers and/or emulsifiers.

In another embodiment, the gelato formulation described herein may further comprise dairy for the making of sherbet.

In one embodiment, the gelato formulation described herein may further comprise dairy for the making of fruit gelato.

In another embodiment, the method of making the gelato formulation described herein may utilise a low temperature pasteurization process. In some embodiments, the method may utilise flash pasteurization.

### DETAILED DESCRIPTION OF THE PREFERRED EMBODIMENTS

The present matter relates to a low-carbohydrate, high protein, fiber enriched gelato formulation and method of manufacturing the same.

It will be understood that while the formulation, described herein, is low in carbohydrate, high in protein and fiber enriched, the combination of ingredients used, and described here also allow the formulation to maintain the taste, body and texture of a traditional gelato.

As stated above, in one aspect, the gelato formulation of the present matter comprises (a) carbohydrates in an amount of from about 0 to about 45% by weight, based on the total weight of the gelato formulation; (b) protein in an amount of from about 0 to about 50% by weight, based on the total weight of the gelato formulation; (c) fiber in an amount of from about 0 to about 30% by weight, based on the total weight of the gelato formulation; (d) polyols (sugar-alcohol) in an amount of from about 0 to about 35% by weight, based on the total weight of the gelato formulation; (e) high-intensity sweetener in an amount of from about 0 to about 10% by weight, based on the total weight of the gelato formulation; (f) sugar in an amount of from about 0 to about 35% by weight, based on the total weight of the gelato formulation; (g) non-fat milk solids in an amount of from about 0 to about 25% by weight, based on the total weight of the gelato formulation; (h) fat in an amount of from about 0 to about 25% by weight, based on the total weight of the gelato formulation; (i) water in an amount of from about 0 to about 85% by weight, based on the total weight of the gelato formulation; (j) flavouring in an amount of from about 0 to about 35% by weight, based on the total weight of the gelato formulation; (k) stabilizer in an amount of from about 0 to about 5% by weight, based on the total weight of the gelato formulation; and (l) emulsifier in an amount of from about 0 to about 5% by weight, based on the total weight of the gelato formulation.

In another aspect, the gelato formulation of the present matter comprises 0-30% carbohydrate by weight, 0-50% protein by weight; 0-30% fiber by weight; 0-35% polyol by weight; 0-10% high intensity sweetener by weight, 0-35% sugar by weight; 0-25% milk solids by weight, 0-30% fat by weight, 0-85% water by weight; 0-35% flavouring by weight; 0-5% stabilizer by weight; and 0-5% emulsifier.

In another embodiment, the low-carbohydrate, high-protein fiber enriched gelato formulation comprises: 0-30% carbohydrate by weight, 0-25% protein by weight, 0-15% fiber by weight, 0-25% polyols by weight, 0-1% high intensity sweetener by weight, 0-25% sugar by weight, 0-15% fat by weight, 0-10% flavouring by weight, 0-15% non-fat milk solids by weight, 0-5% stabilizer by weight, 0-5% emulsifier by weight, and 0-85% water by weight.

In a further embodiment, the low-carbohydrate, high-protein, fiber enriched gelato formulation comprises: 0-15% carbohydrate by weight, 0-25% protein by weight, 0-25% fiber by weight, 0-25% polyols by weight, 0-1% high intensity sweetener by weight, 0-15% sugar by weight, 0-15% fat by weight, 0-10% flavouring by weight, 0-15% milk solids by weight, 0-5% stabilizer by weight, 0-5% emulsifier by weight, and 0-85% water by weight.

In another embodiment, the low-carbohydrate, high-protein, fiber enriched gelato formulation comprises: 0-15% carbohydrates by weight, 8-25% protein by weight, 0-20% fiber by weight, 10-25% polyols by weight, 0-1% high intensity sweetener by weight, 0-25% sugar by weight, 0-20% fat by weight, 0-10% flavouring by weight, 0-15%, non-fat milk solids by weight, 0-1% stabilizer by weight, 0-1% emulsifier by weight, and 45-65% water by weight.

In a further embodiment, the low-carbohydrate, high-protein, fiber enriched gelato formulation comprises: 3-25% carbohydrate by weight, 10-25% protein by weight, 2-10% fiber by weight, 0-25% polyols by weight, 0-1% high intensity sweetener by weight, 0-25% sugar by weight, 0-10% fat by weight, 0-10% flavouring by weight, 0-15% non-fat milk solids by weight, 0-1% stabilizer by weight, 0-1% emulsifier by weight, and 45-70% water by weight.

In one embodiment, the low-carbohydrate, high protein, fiber enriched gelato formulation having high amounts of protein with a total protein content ranging from 8-25% by weight, fiber content ranging from 3-15% by weight, and low-carbohydrate content using polyols (sugar alcohol) ranging from 8-25% by weight.

In a particular embodiment, the low-carbohydrate, high-protein, fiber enriched gelato formulation comprises about 4% carbohydrates by weight, about 17% protein by weight, about 5% fiber by weight, about 15% polyols by weight, about 0% high intensity sweetener and sugar by weight, about 5.5% fat by weight, about 6% flavouring by weight, about 6% non-fat milk solids by weight, about 0.45% stabilizer by weight, about 0.25% emulsifier by weight, and about 54% water by weight.

In another embodiment, the low-carbohydrate, high-protein, fiber enriched gelato formulation comprises: about 5% carbohydrates by weight, about 18% protein by weight, about 5% fiber by weight, about 15% polyols by weight, about 0% high intensity sweetener by weight, about 0% sugar by weight, about 3.5% fat by weight, about 6% flavouring by weight, about 6% non-fat milk solids by weight, about 0.30% stabilizer by weight, about 0.20% emulsifier by weight, and about 53% water by weight.

It will be understood that the amounts provided are based on % by weight of the total formulation.

The term “low-carbohydrate” as used herein is understood to be NET carbohydrate.

A person having ordinary skill in the art would know how to calculate the Net (Effective) carbohydrate content of a food, by subtracting the number of grams of fiber and sugar-alcohols from the number of grams of carbohydrate.

A person having ordinary skill in the art would also know that the total protein content of the finished gelato product is calculated from the main protein source component and any other ingredients that may comprise protein.

### Protein

Protein is a complex, high molecular weight organic compound that consists of amino acids joined by peptide bonds. Protein may be derived from animal or plant sources.

### Whey Protein

Whey protein is a mixture of globular proteins isolated from the liquid material created as a by-product of cheese production known as whey.

Whey protein comes in three major forms: 1) Whey protein concentrates contain lower levels of fat and cholesterol, but have higher levels of carbohydrates in the form of lactose and are about 30% to 89% protein by weight; 2) Whey protein isolates have very little fat and carbohydrates with 90% or more protein by weight; 3) Whey protein hydrolysates are pre-digested and partially hydrolysed whey proteins that are more easily absorbed.

### Dietary Fiber

Dietary fiber found in plants, sometimes called roughage, can be soluble (able to dissolve in water) or insoluble (not able to dissolve in water). Dietary fiber is the part of a plant that provides and maintains the plant's structure. Cellulose, hemicellulose, polysaccharides, pectins, gums, mucilages, and lignins are dietary fibers. These fibers are unrelated chemically, however, they all have one thing in common—they can't be digested by the human body. For this reason, they can help correct disorders of the large intestine (colon), and keep it functioning normally. Therefore, it is important to increase the amount of fiber in the diet.

### Polyols

Polyols occur naturally in plants. They are carbohydrates which are also called “sugar alcohols”. Part of their chemical structure resembles sugar, and part of it resembles alcohol—hence the name. Polyols are like sugar in some ways, but they are not completely absorbed by the body.

The invention provides a method of manufacturing a low-carbohydrate, high protein, fiber enriched gelato formulation, as described herein comprising the steps of: (i) mixing, blending and pre-heating of selected dry and liquid ingredients at 40-60° C. producing a gelato mix; (ii) pasteurizing of the gelato mix; (iii) homogenizing of the gelato mix; (iv) cooling the gelato mix to 2-4° C.; (v) aging the gelato mix for 4-24 hours; and (vi) freezing the gelato mix to −7 to −10° C. with an overrun range of 0-100%.

The gelato mix may then be packaged into the final finished commercial gelato product.

In a preferred embodiment, the mixing, blending and pre-heating, in step (i) occur at temperatures of selected dry and liquid ingredients set at 50° C., slowly adding the dry mixed ingredients while blending using high-speed, high-sheer mixers to fully incorporate powders into the pre-heated liquid ingredients producing a gelato mix.

The gelato mix in step (i) is then pasteurized to destroy microorganisms that can cause spoilage and disease. Pasteurization is commonly used to kill pathogenic bacteria, such as Mycobacterium, Brucella, Salmonella, and Streptococcus. In one embodiment, a high-temperature short-time (HTST) continuous pasteurization is at 82.5° C. for 30 seconds. In another embodiment, batch pasteurization is at 72° C. for 30 minutes. In a preferred embodiment, batch pasteurization is at 69° C. for 32 minutes.

The pasteurized gelato mix is then homogenized, step (iii) to reduce fat droplet size and create a stable emulsion. In one embodiment, a one-stage homogenization uses pressures from about 3,000 psi to about 15,000 psi. In another embodiment, a two-stage homogenization process—the first stage is at 2500 psi and the second stage is at 1500 psi, preferably 2000 psi and 500 psi respectively. In a preferred embodiment, a one-stage homogenization using pressures of about 11,000 psi.

The homogenized gelato mix is then rapidly cooled, step (iv) to prevent microbial contamination using a heat exchanger and transferred to refrigerated storage tanks at a temperature of from 2° C. to 4° C. In a preferred embodiment, refrigerated storage tanks are set at 4° C.

After aging the gelato mix for about 4-24 hours, the gelato formulation is checked for separation, viscosity and weight to determine density and potential overrun. In a preferred embodiment, gelato mix is aged for 24 hours.

Following the ageing process, liquid flavours may be added to the gelato mix just before the freezing process using flavour mixing tanks. Only liquid ingredients can be added before the freezing process, allowing the gelato mix to properly flow through the freezing equipment. The freezing process involves freezing the gelato mix and incorporating air (overrun). In one embodiment, freezing the gelato mix to a temperature range of from −7 to −10° C. and incorporating air to an overrun ranging from 0-100% using batch and/or continuous freezers.

In one embodiment, freezing temperature is −10° C. using a batch freezer with about 35% overrun. In a particular embodiment, freezing temperature is −8° C. using a continuous freezer with about 48% overrun. In a more particular embodiment, the overrun is about 40% with extraction temperature of about −9° C.

Depending on selected flavours of gelato, fruits, nuts, chocolate chips, variegates, swirls, and bulky flavourings (may be low-carbohydrate, high-protein particulates) may be added and uniformly distributed throughout the gelato product after extraction from the freezing processes of batch or continuous methods.

The packaging of the gelato product depends on the desired format selected, for example, cones, cups, tubs, gelato-bars, gelato-bars on a stick, gelato-sandwiches, gelato-cakes, gelato-pies, gelato rolls, moulded items, various family size pack containers, smoothies, milkshakes and other frozen impulse and novelties of the like.

It will be understood that the package type, package size and bundling should not impede heat transfer rapidly cooling and freezing down the packaged gelato product to a holding temperature of −30° C. to −40° C. in blast freezers, and/or hardening tunnels creating small ice crystals. Once completely frozen, the product is then transferred to storage-freezers at a set temperature of −25° C. which will help to stabilize the ice crystals and maintain quality product.

Examples of the protein source that may be used include, but are not limited to, whey protein isolate, whey protein concentrate, whey protein hydrolysate, milk protein isolate, milk protein concentrate, milk protein hydrolysate, soy protein isolate, soy protein concentrate, soy protein hydrolysate, wheat protein, rice protein, plant-derived protein (i.e. tofu), collagen, albumin, gelatin and caseinates. In one embodiment, the protein source may comprise of whey protein concentrate. In another embodiment, the protein source may comprise of whey protein hydrolysate. In some embodiments, the protein source is soy protein isolate. In a preferred embodiment, the protein source is whey protein isolate.

With respect to fiber content, use may be made of beta-glucan, cellulose, chitin and chitosan, fructooligosaccharide (FOS), gums, hemicellulose, inulin, lignin, mucilages, oligofructose, pectin, polydextrose, polyols, psyllium, resistant starch resistant dextrins and resistant maltodextrin. In one embodiment, polydextrose is the source of dietary fiber. In another embodiment, psyllium is the source of dietary fiber. In a preferred embodiment, inulin is the source of dietary fiber.

A person with ordinary skill in the art will know and understand the different physical and functional properties like sweetness, taste and flavour, cooling effect, molecular weight, crystallization, viscosity and freezing point depression, of polyols that are to be used instead of sugars, in low-carb formulation to provide the lowest net carbohydrates in a desired formulation. Use may be made of erythritol, arabitol, xylitol, sorbitol, glycerol, mannitol, lactitol, maltitol, maltitol syrup, mallitol, isomalt, and hydrogenated starch hydrolysate. In one embodiment, the polyols are polydextrose, sorbitol, and maltodextrin. In another embodiment, the polyols polydextrose, sorbitol, and maltitol and glycerine. In another embodiment, the polyols are polydextrose, lactitol, sorbitol and maltodextrin. In a particular embodiment, the polyols are maltitol and sorbitol.

High intensity sweeteners may be used to increase sweetness levels if needed without significantly increasing total solids of the formulations. Use may be made of aspartame, acesulfame potassium, neotame, saccharin, stevia, and sucralose. In one embodiment, the formulation may comprise of aspartame and acesulfame potassium. In a particular embodiment, the formulation contains sucralose as a high intensity sweetener. As for fat content, use may be made of cream, whole milk, whole milk powder, anhydrous butterfat, whole condensed milk, butter, egg yolk, tofu, fat replacers, omega fatty acids, vegetable fat and oil. In one embodiment, the butterfat is from cream. In another embodiment, the butterfat is from butter. In a particular embodiment, the butterfat is from whole milk.

With respect to flavourings, use may be made of vanilla bean, cocoa, nut blends and pastes, coffee, fruit purees, fruit juices, fruit pulps, vegetables, spices, caramel, liquor, liqueur, natural and artificial flavours, extracts, concentrates, and of the like. In one embodiment, the flavouring is strawberry. In another embodiment, the flavouring is mango. In a particular embodiment, the flavouring is hazelnut. In a more particular embodiment, the flavouring is cocoa. In another embodiment, the flavouring is raspberry. In another embodiment, the flavouring is pistachio.

Milk-solids, meaning non-fat, sources may be, for example, whole milk, whole milk powder, skim milk, skim milk powder, condensed whole milk, condensed skim milk, cream, buttermilk, buttermilk powder, whey protein isolate, whey protein concentrate, whey protein hydrolysate, whey powder, evaporated milk, soy milk, soy protein isolate, soy protein concentrate, soy protein hydrolysate, tofu, lactose-free milk, and milk replacers. In one embodiment, the milk solids are from cream and skim milk. In a particular embodiment, the milk-solids are from whole milk.

With respect to stabilizers, use may be made of locust-bean gum, guar gum, carboxymethyl cellulose (CMC), xanthan gum, alginates, carrageenan, cornstarch, pectin, tragacanth gum and gelatin. In one embodiment, the stabilizers may comprise of cornstarch and pectin. In a particular embodiment, the stabilizers are locust-bean gum, guar gum and carrageenan.

With respect to emulsifiers, use may be made of egg yolk, lecithin, mono and diglycerides, polysorbate 80, polysorbates, soy lecithin, propylene glycol monostearate, and glyceryl monostearate (GMS). In one embodiment, the emulsifiers is egg yolk. In another embodiment, the emulsifiers are mono-diglycerides and polysorbate 80. In a particular embodiment, the emulsifier is mono & diglycerides.

It will be understood that the examples provided above are not meant to be limiting and are included as merely examples of the types of ingredients that may be used in the specific formulations described herein.

It will be understood that a person with ordinary skill in the art will know how to calculate the water and moisture content of the selected ingredients to achieve the proper amount of total solids and water needed in a desired formulation. In some embodiments, water is from skim milk, whole milk and cream. In a preferred embodiment, water is primarily from whole milk.

It will be understood that the potential overrun is based on the ingredients, formulation and methods of processing used to produce a finished gelato mix. In one embodiment, overrun range is 25-45%. In another embodiment, the overrun is 50%. In a particular embodiment, the overrun is 40%. In a preferred embodiment, the overrun is 35%.

In some embodiments, the invention may further comprise vitamins, minerals, electrolytes, trace elements, oils, prebiotics, probiotics, kefir, health supplements, phytonutrients, botanicals, nutraceuticals, herbs, amino acids, acidifiers, buffers, salts, and any other of the like to further formulate a complete meal replacement gelato.

In some embodiments, the invention may further comprise energy-related food ingredients such as Caffeine, Taurine, Guarana, B vitamins, Ginseng, Ginkgo Biloba, L-Carnitine, Sugars, and anti-oxidants and of the like to further formulate a high energy, high-protein, high fiber sports gelato.

Sugars may be included to provide energy, for example use may be made of granulated sucrose, liquid sucrose, brown sugar, maltose, honey, maple syrup, molasses, corn syrup, corn syrup solids, high-fructose corn syrup, glucose syrup, glucose solids, invert sugar, dextrose monohydrates, maltodextrines, polydextrose, inulin, fruits, and fruit purees.

There is also provided a method of manufacturing a low-carbohydrate, fiber enriched gelato formulation with high-protein inclusions, the inclusions having about 35-65% protein by weight, to produce a low-carbohydrate, high-protein, fiber enriched gelato formulation, the formulation comprising 0-18% carbohydrates by weight, 0-25% protein by weight, 0-25% polyols by weight, 0-1% high intensity sweetener by weight, 0-3% sugar by weight, 0-8% fat by weight, 0-10% flavouring by weight, 0-2% non-fat milk solids by weight, 0-2% stabilizer by weight, 0-2% emulsifier by weight, and 45-65% water by weight, the method comprises the steps of: (i) mixing, blending and pre-heating of selected liquid and dry ingredients to 40-60° C. producing a gelato mix; (ii) pasteurizing of the gelato mix; (iii) homogenizing of the gelato mix; (iv) cooling to 2-4° C. and aging for 12-24 hours the gelato mix; (v) freezing the gelato mix to −7 to −10° C. with an overrun range of 0-100%; and (vi) adding 20% total particulate inclusions and 10% variegating sauce based on the total weight of the gelato.

The gelato product may then be packaged into the final finished gelato product.

In one embodiment, the protein source is from whey protein isolates and protein bar inclusions.

In another embodiment, the fiber content is inulin and the polyols are maltitol and sorbitol.

In another particular embodiment, high intensity sweetener is sucralose.

In another embodiment, the formulation does not contain any added sugar.

In another embodiment, the butterfat is from whole milk.

In another embodiment, the flavouring is hazelnut.

In another embodiment, the milk-solids are from whole milk.

In another embodiment, the stabilizers are selected from locust-bean gum, guar gum and carrageenan.

In another embodiment, the emulsifier is mono & diglycerides.

In another embodiment, the water is primarily from whole milk.

It will be understood that the low-carbohydrate high-protein inclusions may include low-carbohydrate high-protein particulates and/or low-carbohydrate variegates. Such inclusions/particulates/variegates may be added to the gelato formulation after the initial formulation is prepared. In other words a gelato formulation is prepared, according to the formulations described herein, and then the inclusions/particulates/variegates are added. The addition of such ingredients will therefore increase the overall % of protein within the final product.

Examples of the low-carbohydrate high-protein particulates that may be used include, but are not limited to, low-carb protein bars, low-carb protein brownies, low-carb protein cookies, dairy protein crisps and the like. Examples of the low-carbohydrate variegates that may be used include, but are not limited to, low-carb, caramel sauces, low carb, fudges, and of the like.

In a further embodiment, the net carbohydrate, in the gelato formulation, is 2%-8% by weight, total protein content is 10-25% by weight, fiber content is 2%-10% by weight, based on the total weight of the finished gelato product.

In a further embodiment, the net carbohydrate, in the gelato formulation, is about 5% by weight, total protein content is about 14% by weight, fiber content is about 5% by weight, based on the total weight of the finished gelato product.

The invention also provides a low-carbohydrate, high-protein, fiber enriched gelato formulation comprising: 0-15% carbohydrate by weight, 0-25% protein by weight, 0-25% fiber by weight, 0-25% polyols by weight, 0-1% high intensity sweetener by weight, 0-15% sugar by weight, 0-15% fat by weight, 0-10% flavouring by weight, 0-15% milk solids by weight, 0-5% stabilizer by weight, 0-5% emulsifier by weight, and 0-85% water by weight.

In another embodiment, the invention provides a low-carbohydrate, high-protein gelato formulation comprising: 2-5% carbohydrate by weight, 15-25% protein by weight, 2-8% fiber by weight, 15-22% polyols by weight, 0-1% high intensity sweetener by weight, 5-10% sugar by weight, 0-8% fat by weight, 0-10% flavouring by weight, 0-15% milk solids by weight, 0-1% stabilizer by weight, 0-1% emulsifier by weight, and 55-65% water by weight.

This invention also provides a method of manufacturing a low-carbohydrate, high protein, fiber enriched (soft serve) gelato formulation, the formulation comprising: 0-15% carbohydrate by weight, 0-25% protein by weight, 0-25% fiber by weight, 0-25% polyols by weight, 0-1% high intensity sweetener by weight, 0-15% sugar by weight, 0-15% fat by weight, 0-10% flavouring by weight, 0-15% milk solids by weight, 0-5% stabilizer by weight, 0-5% emulsifier by weight, and 0-85% water by weight, wherein the method comprises the steps of: (i) mixing, blending and pre-heating of selected liquid and dry ingredients to 40-60° C. producing a gelato mix; (ii) pasteurizing the gelato mix; (iii) homogenizing the gelato mix; (iv) cooling the homogenized gelato mix to 2-4° C.; (v) optionally adding liquid flavours to the liquid gelato mix; and (vi) packaging the liquid gelato mix into 5 litre and/or 10 litre bags for Soft-Serve purposes.

The invention also provides a method of producing a low-carbohydrate, high-protein, fiber enriched sorbet-gelato formulation, the formulation comprising: 0-10% carbohydrate by weight, 5-25% protein by weight, 0-25% fiber by weight, 0-28% polyols by weight, 0-1% high intensity sweetener by weight, 0-28% sugar by weight, 0-100% fresh fruit by weight, 0-30% flavouring by weight, and 0-85% water by weight, the method comprising the steps of: (i) mixing the selected dry ingredients in a large container; (ii) preparing a mixture of fruit and water; (iii) slowly adding the mixed dry ingredients to the mixture of step (ii) while blending; (iv) allowing the mixture to stand for 20-30 minutes; (v) freezing the sorbet-gelato mix to −7 to −10° C. and incorporating air to an overrun ranging from 0-100% using batch and/or continuous freezers.

The sorbet-gelato mixture may then be packaged the sorbet-gelato to desired format selected being cones, cups, tubs, gelato-bars, gelato-bars on a stick, gelato-sandwiches, gelato-cakes, gelato-pies, various family size pack containers and other frozen novelties of the like.

In a preferred embodiment, the protein is whey protein isolates, the fiber is inulin and the polyols are maltitol and sorbitol.

In another embodiment, the formulation contains no high intensity sweetener and no added sugar.

In another embodiment, the fresh fruit is raspberry and the water is primarily from the raspberry fruit and water.

In another embodiment, the invention may further comprise stabilizers and/or emulsifiers.

In another embodiment, the invention may further comprise dairy for the making of sherbert.

In another embodiment, the invention may further comprise a low temperature pasteurization process. In an alternative embodiment, the invention may further comprise flash pasteurization.

In another embodiment, the invention may further comprise dairy for the making of fruit gelato.

In one particular embodiment, the low-carbohydrate, high-protein, fiber enriched sorbet-gelato formulation comprises: about 5% carbohydrate by weight, about 15% protein by weight, about 7% fiber by weight, about 13% polyols by weight, about 0% high intensity sweetener by weight, about 0% sugar by weight, about 36% fresh fruit by weight, about 0% flavouring by weight, about 0% stabilizers by weight, about 0% emulsifiers by weight, and about 30% water by weight.

In another embodiment, the invention may further comprise one or more of the following fruits banana, peach, apricot, lemon, raspberry, strawberry, wild berries, mango, passion fruit, guava, pomegranate, orange, blood orange, pear, lime mandarin, calamansi, pineapple, papaya, lychee, kiwi, coconut, rhubarb, pumpkin, plum, cantaloupe, green apple, fig, wild strawberry, redcurrant, cherry, blueberry, cranberry, blackcurrant, black cherry, watermelon, apple, carrot, grape, lemongrass, pink grapefruit, cassis, and combinations thereof.

The gelato formulation(s) of the present matter will be further understood with reference to the examples provided below. The formulations listed in each example have been in accordance with the method(s) described herein.

### Example #1

### Chocolate Gelato Using Whole Milk

| | | |
|---|---|---|
| Formulation: | Milk 3.25% M.F. | 59.8% |
| | Whey Protein Isolates | 15.8% |
| | Maltisweet or Maltisorb | 15.4% |
| | Cocoa Powder | 6.0% |
| | Inulin | 3.0% |
| | | 100.0% |

The formulation contains net carbohydrates 4.38%; total protein 17.68%; dietary fiber 4.66% and total fat 3.44%, non-fat milk solids 5.78%, polyols 15.42%, flavouring 5.98%, stabilizers/emulsifiers 0%, total solids 46.79% and total water content 53.21%.

### Example #2

### Chocolate Gelato Using Water

| | | |
|---|---|---|
| Formulation: | Filtered Water | 59.8% |
| | Whey Protein Isolates | 15.8% |
| | Maltisweet or Maltisorb | 15.4% |
| | Cocoa Powder | 6.0% |
| | Inulin | 3.0% |
| | | 100.0% |

The formulation contains net carbohydrate 1.51%; total protein 15.77%; dietary fiber 4.66%, total fat 1.50%, non-fat milk solids 0.40%, polyols 15.42%, flavourings 5.98%, stabilizers/emulsifiers 0%, total solids 39.47%, total water content 60.53%.

### Example #3

### Hazelnut Gelato Using Whole Milk

| | | |
|---|---|---|
| Formulation: | Milk 3.25% M.F. | 59.8% |
| | Whey Protein Isolates | 14.9% |
| | Maltisweet or Maltisorb | 14.8% |
| | Hazelnut Paste | 6.0% |
| | Inulin | 4.5% |
| | | 100.0% |

The formulation contains net carbohydrates 3.72%; total protein 16.56%; dietary fiber 4.72%; total fat 5.63%; non-fat milk solids 5.80%; polyols 14.82%; flavouring 5.98%; stabilizers/emulsifiers 0%; total solids 46.53% and total water 53.47%.

### Example #4

### Raspberry Sorbet Using Fresh Fruit and Water

| | | |
|---|---|---|
| Formulation: | Fresh Raspberries Pureed | 35.36% |
| | Filtered Water | 30.27% |
| | Whey Protein Isolates | 15.14% |
| | Maltisweet or Maltisorb | 13.17% |
| | Inulin | 6.06% |
| | | 100.0% |

The formulation contains net carbohydrate 2.48%, total protein 14.35%, dietary fiber 7.87%; total fat 0.29%; non-fat milk solids 0.42%; polyols 13.17%; stabilizers/emulsifiers 0%; total solids 37.53% and total water 62.47%.

### Example #5

### Raspberry Sorbet using only fresh fruit

| | | |
|---|---|---|
| Formulation: | Fresh Raspberries Pureed | 72.55% |
| | Whey Protein Isolates | 12.09% |
| | Maltisweet or Maltisorb | 10.52% |
| | Inulin | 4.84% |
| | | 100.00% |

The formulation contains net carbohydrate 4.39%; total protein 12.00%; dietary fiber 9.20%; total fat 0.52%; milk solids non-fat 0.30%; polyols 10.52%; stabilizers/emulsifiers 0%; total solids 34.85% and total water 65.15%.

### Example #6

### Chocolate Gelato using Whole Milk

| | | |
|---|---|---|
| Formulation: | Milk 3.25% M.F. | 59.4% |
| | Whey Protein Isolates | 15.8% |
| | Maltisweet or Maltisorb | 15.3% |
| | Cocoa Powder | 6.0% |
| | Inulin | 3.0% |
| | Stabilizers | 0.3% |
| | Emulsifiers | 0.2% |
| | | 100.0% |

The formulation contains net carbohydrates 4.51%; total protein 17.59%; dietary fiber 4.77% and total fat 3.76%, non-fat milk solids 5.75%, polyols 15.34%, flavouring 5.95%, stabilizers 0.3%, emulsifiers 0.2%, total solids 47.00% and total water content 53.00%.

### Example #7

### Pistachio Gelato Using Whole Milk

| | | |
|---|---|---|
| Formulation: | Milk 3.25% M.F. | 59.5% |
| | Whey Protein Isolates | 14.9% |
| | Maltisweet or Maltisorb | 14.7% |
| | Pistachio Paste | 5.9% |
| | Inulin | 4.5% |
| | Stabilizers | 0.3% |
| | Emulsifiers | 0.2% |
| | | 100.0% |

The formulation contains net carbohydrates 3.85%; total protein 16.51%; dietary fiber 4.83%; total fat 5.94%; non-fat milk solids 5.77%; polyols 14.75%; flavouring 5.95%; stabilizers 0.3%, emulsifiers 0.2%; total solids 46.10% and total water 53.90%.

While this invention has been described with reference to illustrative embodiments and examples, the description is not intended to be construed in a limiting sense. Thus, various modification of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

What is claimed is:

1. A low-carbohydrate, high-protein, fiber enriched gelato formulation comprising:
(a) carbohydrates in an amount of from about 0 to about 45% by weight, based on the total weight of the gelato formulation;
(b) protein in an amount of from about 0 to about 50% by weight, based on the total weight of the gelato formulation;
(c) fiber in an amount of from about 0 to about 30% by weight, based on the total weight of the gelato formulation;
(d) polyols (sugar-alcohol) in an amount of from about 0 to about 35% by weight, based on the total weight of the gelato formulation;
(e) high-intensity sweetener in an amount of from about 0 to about 10% by weight, based on the total weight of the gelato formulation;
(f) sugar in an amount of from about 0 to about 35% by weight, based on the total weight of the gelato formulation;
(g) non-fat milk solids in an amount of from about 0 to about 25% by weight, based on the total weight of the gelato formulation;
(h) fat in an amount of from about 0 to about 25% by weight, based on the total weight of the gelato formulation;
(i) water in an amount of from about 0 to about 85% by weight, based on the total weight of the gelato formulation;
(j) flavouring in an amount of from about 0 to about 35% by weight, based on the total weight of the gelato formulation;
(k) stabilizer in an amount of from about 0 to about 5% by weight, based on the total weight of the gelato formulation; and
(l) emulsifier in an amount of from about 0 to about 5% by weight, based on the total weight of the gelato formulation.

2. The gelato formulation according to claim 1, wherein the formulation comprises 0-15% carbohydrates by weight, 8-25% protein by weight, 0-20% fiber by weight, 10-25% polyols by weight, 0-1% high intensity sweetener by weight, 0-25% sugar by weight, 0-20% fat by weight, 0-10% flavouring by weight, 0-15%, non-fat milk solids by weight, 0-1% stabilizer by weight, 0-1% emulsifier by weight, and 45-65% water by weight.

3. The gelato formulation according to claim 1, wherein the formulation comprises about 5% carbohydrates by weight, about 18% protein by weight, about 5% fiber by weight, about 15% polyols by weight, about 0% high intensity sweetener by weight, about 0% sugar by weight, about 3.5% fat by weight, about 6% flavouring by weight, about 6% non-fat milk solids by weight, about 0.30% stabilizer by weight, about 0.20% emulsifier by weight, and about 53% water by weight.

4. The gelato formulation according to claim 1, wherein the formulation comprises 0-30% carbohydrate by weight, 0-25% protein by weight, 0-15% fiber by weight, 0-25% polyols by weight, 0-1% high intensity sweetener by weight, 0-25% sugar by weight, 0-15% fat by weight, 0-10% flavouring by weight, 0-15% non-fat milk solids by weight, 0-5% stabilizer by weight, 0-5% emulsifier by weight, and 0-85% water by weight.

5. The gelato formulation according to claim 1, wherein the formulation comprises 3-25% carbohydrate by weight, 10-25% protein by weight, 2-10% fiber by weight, 0-25% polyols by weight, 0-1% high intensity sweetener by weight, 0-25% sugar by weight, 0-10% fat by weight, 0-10% flavouring by weight, 0-15% non-fat milk solids by weight, 0-1% stabilizer by weight, 0-1% emulsifier by weight, and 45-70% water by weight.

6. The gelato formulation according to claim 5, wherein the formulation comprises about 4% carbohydrates by weight, about 17% protein by weight, about 5% fiber by weight, about 15% polyols by weight, about 0% sugar by weight, about 0% high intensity sweetener by weight, about 5.5% fat by weight, about 6% flavouring by weight, about 6% non-fat milk solids by weight, about 0.45% stabilizer by weight, about 0.25% emulsifier by weight, and about 54% water by weight.

7. The gelato formulation according to claim 6, wherein the protein content is selected from at least one of whey protein isolate, whey protein concentrate, whey protein hydrolysate, milk protein isolate, milk protein concentrate, milk protein hydrolysate, soy protein isolate, soy protein concentrate, soy protein hydrolysate, wheat protein, rice protein, plant-derived protein, collagen, albumin, gelatine, caseinates or combinations thereof.

8. The gelato formulation according to claim 6, wherein the fiber content is selected from at least one of beta-glucan, cellulose, chitin and chitosan, fructooligosaccharide (FOS), gums, hemicellulose, inulin, lignin, mucilages, oligofructose, pectin, polydextrose, polyols, psyllium, resistant starch resistant dextrins, resistant maltodextrin or combinations thereof.

9. The gelato formulation according to claim 6, further comprises one or more vitamins, minerals, electrolytes, trace elements, oils, health supplements, prebiotics, probiotics, kefir, phytonutrients, botanical, nutraceuticals, herbs, amino acids, acidifiers, buffers, salts and combinations thereof.

10. The gelato formulation according to claim 6, further comprises energy-related food ingredients selected from at least one of caffeine, taurine, guarana, B vitamins, ginseng, ginkgo biloba, L-carnitine, sugars, anti-oxidants or combinations thereof.

11. A method of manufacturing a low-carbohydrate, high-protein, fiber enriched gelato formulation according to claim 1, comprising the steps of:
a. mixing, blending and pre-heating of selected dry and liquid ingredients producing a gelato mix;
b. pasteurizing using batch or continuous pasteurization methods;
c. homogenizing the pasteurized gelato mix using a one-stage or a two-stage homogenization process;
d. rapidly cooling the gelato mix using a heat exchanger to a temperature ranging from 2° C. to 4° C. into refrigerated storage tanks;
e. aging the gelato mix from 4 to 24 hours, and optionally measuring the gelato formulation for separation, viscosity and weight to determine density and potential overrun;
f. optionally adding liquid flavours to the gelato mix using flavour mixing tanks; and
g. freezing the gelato mix to about −7 to −10° C. and incorporating air to an overrun ranging from 0-100% using batch and/or continuous freezing.

12. The method according to claim 11, wherein the batch freezing is set at about −10° C. with an overrun ranging from 0-55% and the continuous freezing is set at about −8° C. with an overrun ranging from 0-55%.

13. The method according to claim 11, further comprising the step of adding bulk flavouring agents to the gelato product after step (g).

14. The method according to claim 12, wherein the overrun range for the batch freezing is about 35% and the overrun range for the continuous freezing is about 48%.

15. A low-carbohydrate, high-protein, fiber enriched, water based, sorbet gelato formulation comprising 0-25% carbohydrate by weight, 5-25% protein by weight, 0-25% fiber by weight, 0-28% polyols by weight, 0-1% high intensity sweetener by weight, 0-28% sugar by weight, 0-100% fruit by weight, 0-30% flavouring by weight and 0-85% water by weight.

16. The sorbet gelato formulation according to claim 15, wherein the protein is whey protein isolates.

17. The sorbet gelato formulation according to claim 15, wherein the fiber is inulin and the polyols are maltitol and sorbitol.

18. The sorbet gelato formulation according to claim 15, further comprises stabilizers and/or emulsifiers.

19. A method of producing a low-carbohydrate, high-protein, fiber enriched, water based, sorbet gelato formulation according to claim 15, comprising the steps of:
a. mix the selected dry ingredients in a large container;
b. preparing a sorbet-gelato mix by mixture of fresh fruit and water and slowly adding the mixed dry ingredients to the dry ingredients while blending;
c. allowing the sorbet-gelato mix to stand for 20-30 minutes;
d. freezing the sorbet-gelato mix to −7 to −10° C. and incorporating air to an overrun ranging from 0-100% using batch and/or continuous-freezers; and
e. optionally package the water-based sorbet-gelato to desired format selected being cones, cups, tubs, gelato-bars, gelato-bars on a stick, gelato-sandwiches, gelato-cakes, gelato-pies, gelato-rolls, moulded items, various family size pack containers and other frozen novelties of the like.

20. A method of manufacturing a low-carbohydrate, high protein, fiber enriched, soft serve gelato formulation, the formulation comprising: 0-15% carbohydrate by weight, 0-25% protein by weight, 0-25% fiber by weight, 0-25% polyols by weight, 0-1% high intensity sweetener by weight, 0-15% sugar by weight, 0-15% fat by weight, 0-10% flavouring by weight, 0-15% milk solids by weight, 0-5% stabilizer by weight, 0-5% emulsifier by weight, and 0-85% water by weight, wherein the method comprises the steps of:
(i) mixing, blending and pre-heating of selected liquid and dry ingredients to 40-60° C. producing a gelato mix;
(ii) pasteurizing the gelato mix;
(iii) homogenizing the gelato mix;
(iv) cooling the homogenized gelato mix to 2-4° C.;
(v) optionally adding liquid flavours to the liquid gelato mix; and
(vi) packaging the liquid gelato mix into 5 litre and/or 10 litre bags for Soft-Serve purposes.
